(19) United States
(12) Patent Application Publication
(10) Pub. No.: US 2012/0141773 A1
(43) Pub. Date: Jun. 7, 2012

(54) ARTICLE FOR MAKING UP THE NAILS AND METHOD FOR MAKING UP THE NAILS BY MEANS OF THE ARTICLE

(75) Inventor: Guillaume Kergosien, Chaville (FR)

(73) Assignee: L'OREAL, PARIS (FR)

(21) Appl. No.: 13/390,345

(22) PCT Filed: Sep. 6, 2010
(86) PCT No.: PCT/EP10/63060

§ 371 Date: Feb. 14, 2012

Related U.S. Application Data
(60) Provisional application No. 61/244,460, filed on Sep. 22, 2009.

(30) Foreign Application Priority Data
Sep. 8, 2009 (FR) 0956115

(51) Int. Cl. A45D 31/00; B32B 5/18; B32B 33/00; A45D 29/00; B32B 27/08

(52) U.S. Cl. 428/315.7; 428/343; 428/334; 132/200; 132/73

(57) ABSTRACT

The invention relates to an article for making up the nails comprising a backing with a profile corresponding to the profile of the nails or capable of conforming to the profile of the nails, the backing having a first face intended to be brought into contact with the nail and a second face on the opposite side from the first, the backing comprising at least one material exhibiting permeability of greater than 1000 g/m²/24 h and the first face comprising a layer of at least one pressure-sensitive adhesive material.

The present invention relates to an article for making up the nails and to a method for making up the nails by means of an article according to the invention.

Conventional false nails are manufactured with plastics, such as acrylonitrile/butadiene/styrene (ABS), indeed even also polyethylene (PE), polypropylene (PP), polyvinyl chloride (PVC), polystyrene (PS) or polyethylene terephthalate (PET).

These materials require the use of specific adhesives for the purpose of obtaining satisfactory hold of the arrangement on the nail. In particular, it is standard to use cyanoacrylates to make a false nail adhere to a nail. This type of adhesive exhibits the disadvantage of comprising irritating ingredients. Furthermore, the use of this type of adhesive is restricting as the adhesive is supplied in an airtight container due to its reactive nature.

Surprisingly, the Applicant Company has discovered that the use of certain materials of high permeability to produce the backing of the false nail makes it possible to use adhesives of pressure-sensitive type which do not exhibit the abovementioned disadvantages of the adhesives used to date while having good properties of hold on the nail.

In addition to the improved hold, these materials of high permeability allow the water occurring at the surface of the nail to evaporate sufficiently rapidly. This makes it possible to minimize the risks of pathologies resulting from accumulation of moisture between the nail and the false nail, such as, for example, onychomycosis, which are frequently encountered with the materials of low permeability as listed above.

These objects are achieved by means of an article for making up the nails comprising a backing with a profile corresponding to the profile of the nails or capable of conforming to the profile of the nails, the backing having a first face intended to be brought into contact with the nail and a second face on the opposite side from the first, the backing comprising at least one material exhibiting a permeability of greater than 1000 g/m²/24 h and the first face comprising a layer of at least one pressure-sensitive adhesive material.

The make-up article according to the invention advantageously exhibits an apparent flexural modulus of elasticity of greater than 100 MPa, preferably of greater than 150 MPa and in particular of greater than 200 MPa. The apparent flexural modulus of elasticity is representative of the flexural strength of the false nail and is measured according to Standard ISO 178. The analysis is carried out at 23° C./50% RH on rods with dimensions of 80×10×4 mm³ on a tensile testing device of Instron® 1175 type at a rate of 2 mm/min.

The total thickness of the backing and of the adhesive layer ranges from 300 μm to 1 mm, in particular from 500 μm to 900 μm and more preferably from 600 μm to 850 μm. This thickness does not include the thickness of the possible removable make-up and/or protective layers covering one and/or other of the first and second faces of the backing.

### Material(s) of High Permeability:

The backing used to produce the make-up articles according to the invention comprises one or more polymeric materials having a high permeability.

Preferably, the material used to produce the make-up article according to the invention exhibits a permeability of greater than 2000 g/m²/24 h and preferably of greater than 3000 g/m²/24 h.

### Permeability of the Material(S) Forming the Backing:

The permeability measurement is given in g/m²/24 h. It is determined by measuring the amount of water vapour in grams which passes through 1 m² of film in 24 hours from a wet region to a dry region (Standard ASTM E 96 E). The operating conditions selected are a relative humidity of 90% and a temperature of 38° C. The measurement is carried out on a sample of film with a thickness of 15 μm. The permeability measurement can be carried out using a device for measuring permeability, such as the device bearing the reference Perme™ W3-060 available from Labthink Instruments Co. Limited.

The polymeric material(s) used to produce the false nail according to the invention preferably comprises at least one polymer chosen from polyamides, polyethers or polyurethanes or from polymers comprising at least one polyamide and/or polyether and/or polyurethane block. Preferably, the material is chosen from polymers comprising at least one polyether block.

Preferably, the material of high permeability comprises a copolymer comprising polyamide blocks (in particular PA-6 or PA-12 blocks) and comprising polyether blocks (in particular polyethylene glycol or polytetramethylene ether glycol blocks), sold in particular under the name Pebax® by Arkema. The choice will preferably be made of the grades Pebax® MV 3000 SA 01 and/or Pebax® MV 6100 SA 01 and/or Pebax® MX 1205 SA 01 and/or Pebax® MV 1041 SA 01 and/or Pebax® MV 1074 SA 01.

According to another embodiment, the material used to produce the false nail comprises a poly(ether/ester) copolymer. In particular, the material is a copolyester produced from dimethyl 1,4-cyclohexanedicarboxylate, 1,4-cyclo-hexanedimethanol and poly(tetramethylene ether glycol). Such compounds are sold in particular by Eastman Chemical Company under the range bearing the reference Ecdel Elastomers. The material can also be chosen from polybutylene terephthalate and polyether glycol block copolymers, the polybutylene terephthalate being produced from dimethyl terephthalate and 1,4-butanediol. Such compounds are available in particular from DuPont in the Hytrel® range.

According to another embodiment, the material used to produce the false nail according to the invention can comprise a microporous material preferably having pore diameters of less than 10 μm, preferably of less than 1 μm, preferably of less than 500 nm, preferably of less than 100 nm, such as a microporous polyolefin, a microporous polyester, a microporous polyamide, a microporous polyurethane or a microporous polytetrafluoroethylene (PTFE). Laminates based on microporous PTFE are available in particular from W. L. Gore & Associates Inc.

The polymeric material of high permeability used to produce the false nail can be present in a content ranging from 10% to 100% by weight, with respect to the total weight of the false nail, preferably ranging from 30% to 100% by weight, more preferably ranging from 50% to 100% by weight.

### Wax(es):

The backing can additionally comprise one or more waxes exhibiting a melting point of less than 70° C., preferably of less than 60° C. The presence of such wax(es) in the backing of the false nail according to the invention makes it possible during the application of the false nail, in particular by heating by means of a hairdryer, to bring the false nail perfectly into conformity with the profile of the nail on which it is applied.

The wax optionally used in the false nail according to the invention exhibits a melting point of less than 70° C., preferably of less than 60° C. This makes it possible, during the application on the nail, to change in plastic fashion the shape of the arrangement by heating it in particular to a temperature in the vicinity of 60° C. to 70° C., so as to match it to the shape of the nail. The said wax is preferably a polyolefin or an olefin copolymer, preferably a homopolymer or a copolymer of ethylene and/or of propylene. The said wax is preferably composed of a CₙH₂ₙ₊₂ alkyl chain with n less than 40 and with n preferably between 20 and 40.

More generally, the wax under consideration in the context of the present invention is generally a lipophilic compound which is solid at ambient temperature (25° C.), which can or cannot be changed in shape, which exhibits a reversible solid/liquid change in state and which has a melting point of greater than or equal to 30° C. which can range up to 70° C., and in particular up to 60° C.

Within the meaning of the invention, the melting point corresponds to the temperature of the most endothermic peak observed by thermal analysis (DSC) as described in Standard ISO 11357 3; 1999. The melting point of the wax can be measured using a differential scanning calorimeter (DSC), for example the calorimeter sold under the name “MDSC 2920” by TA Instruments.

The measurement protocol is as follows:

A 5 mg sample of wax placed in a crucible is subjected to a first rise in temperature ranging from −20° C. to 100° C. at a heating rate of 10° C./minute, is then cooled from 100° C. to −20° C. at a cooling rate of 10° C./minute and, finally, is subjected to a second rise in temperature ranging from −20° C. to 100° C. at a heating rate of 5° C./minute. During the second rise in temperature, the variation in the difference in power absorbed by the empty crucible and by the crucible containing the sample of wax is measured as a function of the temperature. The melting point of the compound is the value of the temperature corresponding to the tip of the peak of the curve representing the variation in the difference in power absorbed as a function of the temperature.

The waxes capable of being used in the compositions according to the invention are chosen from waxes of animal, vegetable, mineral or synthetic origin, and their mixtures, which are solid at ambient temperature.

The waxes which can be used in the compositions according to the invention generally exhibit a hardness ranging from 0.01 MPa to 15 MPa, in particular of greater than 0.05 MPa and especially of greater than 0.1 MPa.

The hardness is determined by the measurement of the compressive force measured at 20° C. using the texture analyser sold under the name TA-XT2 by Rheo, equipped with a stainless steel cylinder with a diameter of 2 mm which is displaced at the measuring rate of 0.1 mm/s and which penetrates the wax to a penetration depth of 0.3 mm.

The measurement protocol is as follows:

The wax is melted at a temperature equal to the melting point of the wax +10° C.

The molten wax is cast in a receptacle with a diameter of 25 mm and a depth of 20 mm. The wax is recrystallized at ambient temperature (25° C.) for 24 hours, so that the surface of the wax is flat and smooth, and then the wax is stored at 20° C. for at least one hour before measuring the hardness or the tack.

The rotor of the texture analyser is displaced at a rate of 0.1 mm/s and then penetrates the wax to a penetration depth of 0.3 mm. When the rotor has penetrated the wax to the depth of 0.3 mm, the rotor is held stationary for 1 second (corresponding to the relaxation time) and is then withdrawn at the rate of 0.5 mm/s.

The value of the hardness is the maximum compressive force measured divided by the surface area of the cylinder of the texture analyser in contact with the wax.

Mention may in particular be made, by way of illustration of the waxes suitable for the invention, of hydrocarbon waxes, such as beeswax, microcrystalline waxes, paraffin waxes, polyethylene waxes, the waxes obtained by the Fischer-Tropsch synthesis and waxy copolymers, and their esters, or the waxes obtained by catalytic hydrogenation of animal or vegetable oils having linear or branched C₈-C₃₂ fatty chains. Mention may also be made of silicone waxes or fluorinated waxes.

The wax in the article in accordance with the invention is generally used in a proportion ranging from 1% to 90%, preferably from 5% to 60%, preferably from 10% to 30%, with respect to the total weight of the backing.

Of course, the nature and/or the amount of wax used, if appropriate, will be chosen so that the article retains a satisfactory permeability to water vapour.

### Adhesive Layer:

The article according to the invention has a layer of at least one pressure-sensitive adhesive (PSA). The adhesive material can comprise a polymer or a polymeric system which can comprise one or more polymers of different natures. This adhesive material can in addition comprise a plasticizer.

The adhesive materials according to the invention are, for example, those mentioned in the “Handbook of Pressure Sensitive Adhesive Technology”, 3rd Edition, D. Satas.

The adhesive materials according to the invention can in particular comprise polymers chosen from: polyurethanes; acrylic polymers; silicones, in particular from Bio-PSAs; butyl rubbers, in particular from polyisobutylenes; ethylene/vinyl acetate polymers; polyamides optionally modified by fatty chains; natural rubbers; and their blends.

They can in particular be adhesive copolymers deriving from the copolymerization of vinyl monomers with polymeric entities, such as, for example, those described in U.S. Pat. No. 6,136,296. The adhesive copolymers described in U.S. Pat. No. 5,929,173, having a polymer backbone, with a Tg varying from 0° C. to 45° C., grafted with chains deriving from acrylic and/or methacrylic monomers which have, on the other hand, a Tg varying from 50° C. to 200° C., are also capable of being suitable for the invention.

The adhesive materials according to the invention can in particular comprise polymers chosen from block or random copolymers comprising at least one monomer or a combination of monomers having a resulting polymer with a glass transition temperature below ambient temperature (25° C.), it being possible for these monomers or combination of monomers to be chosen from butadiene, ethylene, propylene, isoprene, isobutylene, a silicone and their blends. Examples of such materials are block polymers of styrene/butadiene/styrene, styrene/(ethylene/butylene)/styrene or styrene/isoprene/styrene type, such as those sold under the trade names “Kraton” by Kraton or “Vector” by Dexco Polymers.

The adhesive materials according to the invention can additionally comprise tackifying resins, such as rosins or rosin derivatives, such as hydrogenated rosins, rosin esters or hydrogenated rosin esters, terpenes, aliphatic or aromatic hydrocarbon resins, phenolic resins, styrene resins and coumarone/indene resins. Mention will also be made of compounds such as shellac, gum sandarac, dammars, elemi, copals, benzoin and mastic gum.

According to a specific form of the invention, the adhesive layer comprises from 5 to 25% and in particular from 10 to 20% of at least one residual solvent, the said article being packaged in a packaging leaktight to the said solvent in order to prevent the solvent from evaporating before the arrangement is used.

The adhesive material in the article in accordance with the invention is generally in the form of a layer having a thickness ranging from 1 μm to 100 μm and in particular from 5 μm to 50 μm, preferably from 10 μm to 40 μm.

According to another aspect, the invention relates to a method for making up the nails which consists in adhesively bonding to the nail, by means of a pressure-sensitive adhesive material, an article comprising a backing with a profile corresponding to the profile of the nails or capable of conforming to the profile of the nails, the backing comprising at least one material exhibiting a permeability of greater than 1000 g/m²/24 h.

The method according to the invention can additionally comprise a stage consisting in applying, to the second face of the backing, at least one liquid composition comprising at least one ingredient chosen from film-forming agents, plasticizers, solvents, colouring materials and their mixtures. Such compositions are well known and consequently do not require any additional detailed description. This coating by means of a composition of nail varnish type can be carried out during the production of the article or at the time of use.

According to yet another aspect, the invention relates to a kit for making up the nails comprising:

i) a backing with a profile corresponding to the profile of the nails or capable of conforming to the profile of the nails, the backing having a first face intended to be brought into contact with the nail and a second face on the opposite side from the first, the backing comprising at least one material exhibiting a permeability of greater than 1000 g/m²/24 h, and

ii) an adhesive composition comprising at least one pressure-sensitive adhesive material, the said composition being intended to adhesively bond the first face of the backing to a nail.

When used, the user coats the nail and/or the first face of the backing with the said adhesive composition. She subsequently applies the backing to the nail via its first face.

### EXAMPLE

Pebax MV 6100 SA 01 granules are heated to a temperature of 250° C. and then coated onto a teflon-covered backing, so as to obtain a film with a thickness of 600 μm.

The material used to produce this film exhibits a permeability of greater than 2000 g/m²/24 h (thickness of the film: 15 μm, 38° C., 90% RH).

The film obtained is subsequently thermoformed and cut up so as to conform perfectly to the shape of the nails of the users. In order to do this, moulds are prepared beforehand from the nails of the users in order to reproduce exactly the impressions of the nails. These moulds are subsequently used to thermoform the false nails to the exact shapes of the nails. The false nails thus produced exhibit a thickness of 600 μm. The false nails are subsequently coated with an adhesive layer with a thickness of 25 μm produced from the PSA adhesive “Roderm MD-5800” available from Dow Chemical.

On evaluation, the arrangements thus produced make it possible to obtain good hold of the adhesion over time. To obtain such a hold with a film of high density polyethylene (HDPE) with a thickness of 600 μm instead of the film of Pebax MV 6100 SA 01 would have required the use of adhesives of the type of those used in conventional false nail systems.

1. An article for making up nails, the article comprising a backing having a profile corresponding to a profile of the nails or a profile capable of conforming to the profile of the nails, the backing having a first face and a second face on an opposite side from the first face, the backing comprising a material having a permeability of greater than 1000 g/m²/24 h and the first face comprising a layer of at least one pressure-sensitive adhesive material.

2. The article of claim 1, wherein the material has a permeability of greater than 2000 g/m²/24 h.

3. The article of claim 1, having an apparent flexural modulus of elasticity of greater than 100 MPa.

4. The article of claim 1, wherein the backing comprises at least one polymer selected from the group consisting of:
a polyamide,
a polyether,
a polyurethane, and
a polymer comprising at least one block selected from the group consisting of a polyamide block, a polyether block, and a polyurethane block.

5. The article of claim 4, wherein the at least one polymer is at least one selected from the group consisting of
a copolymer comprising a polyamide block and a polyether block,
a copolyester comprising, in reacted form, dimethyl 1,4-cyclohexanedicarboxylate, 1,4-cyclohexanedimethanol and poly(tetramethylene ether glycol), and
a block copolymer of polybutylene terephthalate and a polyether glycol.

6. The article of claim 1, wherein the material is a microporous material having pores with a diameter of less than 10 μm.

7. The article of claim 6, wherein the microporous material is selected from the group consisting of a microporous polyolefin, a microporous polyester, a microporous polyamide, a microporous polyurethane, and a microporous polytetrafluoroethylene (PTFE).

8. The article of claim 1, wherein the backing comprises 10% to 100% of the material by weight, with respect to a total weight of the backing.

9. The article of claim 1, wherein the backing further comprises a wax having a melting point of less than 70° C.

10. The article of claim 9, wherein the wax is selected from the group consisting of a polyolefin copolymer wax, an olefin copolymer wax, a homopolymer of ethylene, a homopolymer of propylene, and a copolymer of ethylene and propylene.

11. The article of claim 1, wherein the backing and the adhesive layer have a combined thickness of 300 μm to 1 mm.

12. The article of claim 1, wherein the pressure-sensitive adhesive material is at least one selected from the group consisting of a polyurethane, an acrylic polymer, a silicone, a butyl rubber, an ethylene/vinyl acetate polymer, a polyamide, a polyamide modified by a fatty chain, a natural rubber, a block copolymer comprising at least one monomer selected from the group consisting of butadiene, ethylene, propylene, isoprene, isobutylene and a silicone, a rosin, a rosin derivative, a hydrogenated rosin, a rosin ester, a hydrogenated rosin ester, a terpene, an aliphatic hydrocarbon resin, an aromatic hydrocarbon resin, a phenolic resin, a styrene resin, a coumarone resin, and an indene resin.

13. The article of claim 1, wherein the layer of at least one pressure-sensitive adhesive material comprises 5 to 25% of a residual solvent, the article being packaged in a packaging leaktight to the residual solvent.

14. The article of claim 1, wherein the layer of at least one pressure-sensitive adhesive material has a thickness of 1 μm to 100 μm.

15. A method for making up nails, the method comprising adhesively bonding to the nails an article comprising a backing having a profile corresponding to a profile of the nails or a profile capable of conforming to the profile of the nails, the backing comprising a material having a permeability of greater than 1000 g/m²/24 h, and the backing comprising a pressure-sensitive adhesive material.

16. A kit for making up the nails, comprising:
i) a backing having a profile corresponding to a profile of the nails or a profile capable of conforming to the profile of the nails, the backing having a first face and a second face on an opposite side from the first face, the backing comprising a material having a permeability of greater than 1000 g/m²/24 h, and
ii) an adhesive composition comprising a pressure-sensitive adhesive material.

17. The article of claim 1, wherein the material has a permeability of greater than 3000 g/m²/24 h.

18. The article of claim 1, having an apparent flexural modulus of elasticity of greater than 200 MPa.

19. The article of claim 1, wherein the material is a microporous material having pores with a diameter of less than 100 nm.

20. The article of claim 1, wherein the backing comprises 50% to 100% of the material by weight, with respect to a total weight of the backing.
